(19) United States
(12) Patent Application Publication
(10) Pub. No.: US 2017/0305467 A1
(43) Pub. Date: Oct. 26, 2017

(54) METHOD AND APPARATUS FOR THE ASSISTED GUIDANCE OF A VEHICLE

(71) Applicant: Robert Bosch GmbH, Stuttgart (DE)

(72) Inventor: Stefan Nordbruch, Kornwestheim (DE)

(21) Appl. No.: 15/520,716

(22) PCT Filed: Oct. 22, 2015
(86) PCT No.: PCT/EP2015/074487

§ 371 Date: Apr. 20, 2017

(30) Foreign Application Priority Data
Nov. 26, 2014 (DE) 10 2014 224 075.1

(51) Int. Cl. B62D 15/02

(52) U.S. Cl. CPC B62D 15/0285; B62D 15/027; B62D 15/02

(57) ABSTRACT

A method for the assisted guidance of a vehicle, whereby a setpoint trajectory to be traversed in a parking facility is ascertained for the vehicle as a function of a type of the vehicle, the ascertained setpoint trajectory being transmitted to the vehicle via a communication network, so that the vehicle is able to travel autonomously in the parking facility based on the setpoint trajectory. An apparatus for the assisted guidance of a vehicle, a method or an apparatus for operating a vehicle, a parking system for vehicles, a vehicle and a computer program, are also described.

### FIELD

The present invention relates to a method and an apparatus for the assisted guidance of a vehicle. The present invention also relates to a method and an apparatus for operating a vehicle. In addition, the present invention relates to a parking system for vehicles, a vehicle, as well as a computer program.

### BACKGROUND INFORMATION

German Patent Application No. DE 10 2012 222 562 A1 describes a system for managed parking areas for transferring a vehicle from a starting position to a target position.

In the case of fully automated (autonomous) so-called valet parking, a vehicle is parked by its driver at a drop-off location, for example, in front of a parking garage, and from there, the vehicle drives on its own into a parking position/parking space, and back again to the drop-off location.

### SUMMARY

An object of the present invention includes providing efficient autonomous travel of the vehicle in a parking facility.

Advantageous developments of the present invention are described herein.

According to one aspect of the present invention, a method is provided for the assisted guidance of a vehicle, whereby a setpoint trajectory to be traversed in a parking facility is ascertained for the vehicle as a function of a type of the vehicle, the ascertained setpoint trajectory being transmitted to the vehicle via a communication network, so that the vehicle is able to drive autonomously in the parking facility based on the setpoint trajectory.

According to another aspect, an apparatus is provided for the assisted guidance of a vehicle, including a processor which is designed to ascertain for the vehicle, a setpoint trajectory to be traversed in a parking facility as a function of a type of the vehicle, and a communication interface which is designed to transmit the ascertained setpoint trajectory to the vehicle via a communication network, so that the vehicle is able to travel autonomously in the parking facility based on the setpoint trajectory.

According to a further aspect, a method is provided for operating a vehicle, a setpoint trajectory, which is a function of a type of the vehicle and is to be traversed in a parking facility, being received by the vehicle via a communication network, the vehicle traveling autonomously in the parking facility based on the setpoint trajectory.

According to another aspect, an apparatus is provided for operating a vehicle, including a communication interface which is designed to receive, via a communication network, a setpoint trajectory that is a function of a type of the vehicle and is to be traversed in a parking facility, and including a guidance device for guiding the vehicle, which is designed to guide the vehicle autonomously in the parking facility based on the setpoint trajectory.

According to another aspect, a parking system is provided for vehicles, the parking system including a parking facility and the apparatus for the assisted guidance of a vehicle.

According to another aspect, a vehicle is provided which includes the apparatus for operating a vehicle.

According to a further aspect, a computer program is provided which includes program code to carry out the method for the assisted guidance of a vehicle and/or for the operation of a vehicle, when the computer program is executed on a computer.

Thus, in particular, the present invention includes ascertaining a setpoint trajectory for the vehicle as a function of the type of the vehicle. In other words, an optimal setpoint trajectory, tailored to the vehicle and over which the vehicle is intended to travel in the parking facility, is ascertained specifically for the vehicle. Therefore, according to the present invention, it is not provided to determine one general, common setpoint trajectory for various different vehicles. Rather, a separate setpoint trajectory is ascertained for each individual vehicle as a function of its vehicle type. A setpoint trajectory may thereby be optimized for the vehicle in advantageous fashion. In particular, characteristic features of the vehicle specifically driving in the parking facility may thereby be taken into account in beneficial manner. Notably, an efficient autonomous travel of the vehicle in the parking facility is thus advantageously made possible.

According to one specific embodiment, the communication network includes a WLAN network and/or a mobile radio network.

In one specific embodiment, a communication via the communication network is encrypted.

A parking facility within the meaning of the present invention may also be referred to as a parking lot, and is used as parking area for vehicles. Specifically, the parking facility thus forms one coherent area which has a plurality of parking spaces (in the case of a parking facility on private property) or parking spots (in the case of a parking facility on public property). According to one specific embodiment, the parking facility may be comprised of a car park. In particular, the parking facility is comprised of a garage.

Autonomous for the purposes of the present invention means, in particular, that the vehicle navigates or drives or is guided independently in the parking facility, that is, without intervention by a driver. Thus, the vehicle drives independently in the parking facility, without a driver having to control the vehicle or be in the vehicle for that purpose. In particular, guidance includes lateral guidance and/or longitudinal guidance of the vehicle. Such an autonomously driving vehicle which is able to get into and out of a parking space automatically is known, for example, as an AVP vehicle. AVP stands for “automatic valet parking” and may be translated by “automatic parking process.” Vehicles which do not have this AVP functionality are referred to as standard vehicles, for example.

A drop-off position within the meaning of the present invention is a position at which a driver of the vehicle is able to switch off his vehicle for an autonomous parking process, and from which he may pick up his vehicle again at a later time.

A parking position within the meaning of the present invention is a position at which the vehicle is intended to park autonomously.

A pick-up position within the meaning of the present invention is a position at which a vehicle may be picked up at the end of an autonomous parking process.

According to one specific embodiment, the drop-off position is the same as the pick-up position.

In one specific embodiment, the vehicle navigates or drives autonomously from the drop-off position to the parking position.

In a further specific embodiment, the vehicle parks autonomously in the parking position.

In another specific embodiment, the vehicle gets autonomously out of the parking position.

According to a further specific embodiment, the vehicle navigates or drives autonomously from the parking position to the pick-up position.

According to one specific embodiment, the setpoint trajectory is also ascertained as a function of at least one of the following vehicle parameters: Wheel base, height, width, length, mass, functional scope of a driver assistance system, functional scope of a driving-environment sensor system, maximum steering angle, turning clearance circle, inexactness of a driver assistance system and inexactness of a driving-environment sensor system, specific type and/or a specific inexactness of one or more actuators, e.g., brake, steering, drive, and/or of a processing device for calculating control parameters for one or more actuators, in order to be able to travel over the setpoint trajectory.

In particular, this yields the technical advantage that the setpoint trajectory may be adapted even better to the vehicle. Thus, an improved, efficient, autonomous navigation of the vehicle in the parking facility may be rendered possible in advantageous manner.

For example, the functional scope of a driving-environment sensor system includes a sensing range of a driving-environment sensor. Therefore, for instance, a sensing range of a video sensor, a radar sensor, an ultrasonic sensor, a laser sensor or a lidar sensor. Thus, as a rule, accuracy of a camera including a video sensor decreases with distance.

For example, the functional scope of a driving-environment sensor system includes a sensitivity of a driving-environment sensor.

Since, as a rule, a driver assistance system uses driving-environment sensor data of a driving-environment sensor system for the implementation of a driver assistance function, a functional scope of the driver assistance system is also defined by the functional scope of the driving-environment sensor system.

For instance, the functional scope of a driver assistance system includes a speed of reaction to an event such as the appearance of an obstacle.

According to a further specific embodiment, a plurality of vehicle parameters are provided.

The motion-control regulator is a processing device which calculates the implementation of a setpoint trajectory, that is, how individual actuators (brake, steering, drive) must be controlled so that the setpoint trajectory is traversed. In other words, the processing device is designed to calculate control parameters for one or more actuators, in order to be able to travel over the setpoint trajectory.

According to one specific embodiment, the vehicle type includes the model year of the vehicle.

According to a further specific embodiment, the vehicle type includes a world manufacturer identifier of a manufacturer of the vehicle.

In another specific embodiment, at least one localization-synchronization location is determined, by which the vehicle is able to check whether it is traveling correctly over the ascertained setpoint trajectory, the localization-synchronization location being transmitted via the communication network to the vehicle, so that when traversing the setpoint trajectory, the vehicle is able to check, with the aid of the localization-synchronization location, whether it is traveling correctly over the setpoint trajectory.

In particular, this yields the technical advantage that the vehicle is able to recognize when it is no longer traveling correctly over the setpoint trajectory. The vehicle is then able to correct the deviation. Autonomous travel of the vehicle in the parking facility is thereby able to be improved.

According to a further specific embodiment, the determination of the localization-synchronization location includes that position data of the localization-synchronization location is determined relative to the setpoint trajectory.

In particular, this brings about the technical advantage that the vehicle is able to recognize, relative to the setpoint trajectory to be traversed, whether or not it is traveling over it correctly, for the localization-synchronization location is indicated based on the setpoint trajectory.

Thus, for example, according to one specific embodiment, the following information is assigned to a localization-synchronization location: At a defined point in the setpoint trajectory, the localization-synchronization location is at a specific distance in the direction of an abscissa of a Cartesian coordinate system and at a predetermined distance in the direction of an ordinate of the Cartesian coordinate system and/or an angle between the line segment or straight line, which connects the predetermined point of the setpoint trajectory to the localization-synchronization location, and one of the two axes of the Cartesian coordinate system, thus, the abscissa or the ordinate, has a predetermined angular value. For example, the information as to how great the distance (linear distance) is between the defined point in the setpoint trajectory and the localization-synchronization location is assigned to the localization-synchronization location.

For example, the Cartesian coordinate system is the world coordinate system or the vehicle coordinate system or the map coordinate system. For instance, the Cartesian coordinate system is a coordinate system in relation to the setpoint trajectory.

According to a further specific embodiment, prior to a transmission, at least one section of the ascertained setpoint trajectory is approximated by a straight line or a sequence of points, so that instead of the ascertained setpoint trajectory, the setpoint trajectory with the approximated section is transmitted to the vehicle via the communication network.

Notably, this yields the technical advantage that because of the approximation, less data needs to be transmitted to the vehicle via the communication network. A volume of data to be transmitted may thus be reduced. Advantageously, the communication via the communication network may therefore be carried out especially efficiently.

According to one specific embodiment, several sections are approximated according to the explanations given above. Thus, for example, one section is approximated by a straight line. Preferably, another section is approximated by a sequence of points. Sections of the setpoint trajectory which are not approximated are transmitted as a whole, thus, as entire section, therefore, as non-approximated section, via the communication network to the vehicle.

According to one specific embodiment, a plurality of localization-synchronization locations are provided.

According to another specific embodiment, the setpoint trajectory includes at least one of the following locations in the parking facility: Drop-off position at which a driver of the vehicle is able to drop off his vehicle for an autonomous parking process, parking position in which the vehicle parks in the parking facility, pick-up position at which a driver of the vehicle is able to pick up the vehicle at the end of an autonomous parking process.

In other words, depending upon which of the aforesaid locations are included in the setpoint trajectory, the vehicle is thus able to drive autonomously from the drop-off position to the parking position by traveling autonomously over the setpoint trajectory. In particular, the vehicle is able to park there, thus, get into the parking position, autonomously. Notably, the vehicle is able to get out of the parking position. In particular, the vehicle is able to drive autonomously from the parking position to the pick-up position which corresponds, for example, to the drop-off position

That is, by traversing the setpoint trajectory, an automatic parking process, what is referred to as automatic valet parking (AVP) is thus able to be achieved.

In this context, the vehicle is assisted in its autonomous travel in so far as the setpoint trajectory to be traversed is transmitted to the vehicle via the communication network. The vehicle drives independently, thus autonomously, in the parking facility based on the transmitted setpoint trajectory. In particular, no remote control of the vehicle takes place here.

According to a further specific embodiment, it is provided to refrain from transmitting a digital map of the parking facility to the vehicle via the communication network.

Notably, this yields the technical advantage that even less data has to be transmitted to the vehicle. A digital map normally has a considerable size, so that the corresponding map data needs memory space. In particular, generally, transmission of such a digital map would take up a certain time. However, because the transmission of such a digital map to the vehicle is dispensed with, a data-transmission volume and memory requirements may be cut back or reduced in advantageous manner. That is to say, in particular, the vehicle thus does not have to reserve any memory for the digital map of the parking facility.

According to one specific embodiment, the apparatus for the assisted guidance of a vehicle is designed or equipped to implement or carry out the method for the assisted guidance of a vehicle.

According to one specific embodiment, the apparatus for operating a vehicle is designed or equipped to implement or carry out the method for operating a vehicle.

According to a further specific embodiment, the vehicle is designed or equipped to implement or carry out the method for operating a vehicle.

According to one specific embodiment, the parking position is determined as a function of the type of vehicle. Specifically, the technical advantage may thus be attained that the vehicle fits in a parking position optimized for it in the parking facility, for usually not every type of vehicle fits equally well in every parking position. Thus, for example, a column near a parking position may make it considerably more difficult to get an all-terrain vehicle into or out of the parking position, while as a rule, a small vehicle has no problems with it.

In one specific embodiment, the parking position is determined as a function of at least one of the following vehicle parameters: Wheel base, height, width, length, mass, functional scope of a driver assistance system, functional scope of a driving-environment sensor system, maximum steering angle, turning clearance circle, inexactness of a driver assistance system and inexactness of a driving-environment sensor system. In this manner, the parking position for the vehicle may be selected even more appropriately.

In one specific embodiment, the determination of the parking position includes selecting one parking position from a multitude of parking positions in the parking facility.

According to one specific embodiment, autonomous driving of the vehicle in the parking facility is monitored with the aid of a monitoring system external to the vehicle.

According to one specific embodiment, the monitoring system includes one or more video cameras and/or one or more radar sensors and/or one or more ultrasonic sensors and/or one or more lidar sensors and/or one or more laser sensors and/or one or more photoelectric light barriers and/or one or more door-opening sensors.

Functionalities of the methods are yielded analogously from corresponding functionalities of the apparatuses and vice versa. That is, method features are thus obtained analogously from corresponding apparatus features and vice versa. In other words, namely, if a feature is described in connection with the method or the apparatus for the assisted guidance of a vehicle, this feature may therefore be provided analogously in specific embodiments of the method and of the apparatus for operating a vehicle and vice versa.

The present invention is explained in greater detail below on the basis of preferred exemplary embodiments.

### BRIEF DESCRIPTION OF THE DRAWINGS

FIG. 1 shows a flowchart of a method for the assisted guidance of a vehicle.

FIG. 2 shows an apparatus for the assisted guidance of a vehicle.

FIG. 3 shows a flowchart of a method for operating a vehicle.

FIG. 4 shows an apparatus for operating a vehicle.

FIG. 5 shows a parking system for vehicles.

FIG. 6 shows a vehicle.

FIG. 7 shows a parking facility.

FIG. 8 shows the parking facility according to FIG. 7, including localization-synchronization locations.

FIG. 9 shows a setpoint trajectory.

FIG. 10 shows the setpoint trajectory from FIG. 9, which is approximated by a sequence of points.

FIG. 11 shows the trajectory of FIG. 9, which is approximated by a sequence of straight lines.

### DETAILED DESCRIPTION OF EXAMPLE EMBODIMENTS

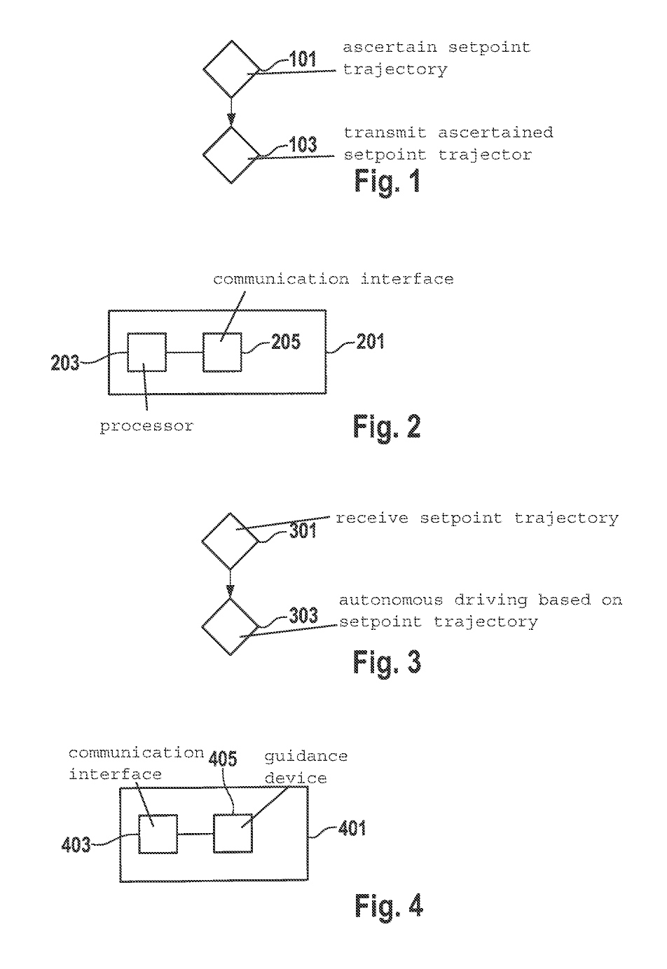

FIG. 1 shows a flowchart of a method for the assisted guidance of a vehicle.

According to a step 101, a setpoint trajectory to be traversed in a parking facility is ascertained for the vehicle as a function of a type of the vehicle. In a step 103, the ascertained setpoint trajectory is transmitted to the vehicle via a communication network. In particular, this provides the technical advantage that the vehicle is able to drive autonomously in the parking facility based on the setpoint trajectory. For example, the vehicle is an APV vehicle.

FIG. 2 shows an apparatus 201 for the assisted guidance of a vehicle.

Apparatus 201 includes a processor 203, which is designed to ascertain for the vehicle, a setpoint trajectory to be traversed in a parking facility as a function of a type of the vehicle. Apparatus 201 also includes a communication interface 205, which is designed to transmit the ascertained setpoint trajectory to the vehicle via a communication network, so that the vehicle is able to drive autonomously in the parking facility based on the setpoint trajectory.

FIG. 3 shows a flowchart of a method for operating a vehicle.

According to a step 301, a setpoint trajectory, which is a function of a type of the vehicle and is to be traversed in a parking facility, is received by the vehicle via a communication network. In a step 303, the vehicle drives autonomously in the parking facility based on the setpoint trajectory.

According to one specific embodiment, the setpoint trajectory includes one or more localization-synchronization locations, by which the vehicle is able to check when traversing the setpoint trajectory, whether or not it is traveling correctly over the setpoint trajectory.

FIG. 4 shows an apparatus 401 for operating a vehicle.

Apparatus 401 includes a communication interface 403, which is designed to receive, via a communication network, a setpoint trajectory that is a function of a type of the vehicle and is to be traversed in a parking facility. Apparatus 401 also includes a guidance device 405 for guiding the vehicle, which is designed to guide the vehicle autonomously in the parking facility based on the setpoint trajectory.

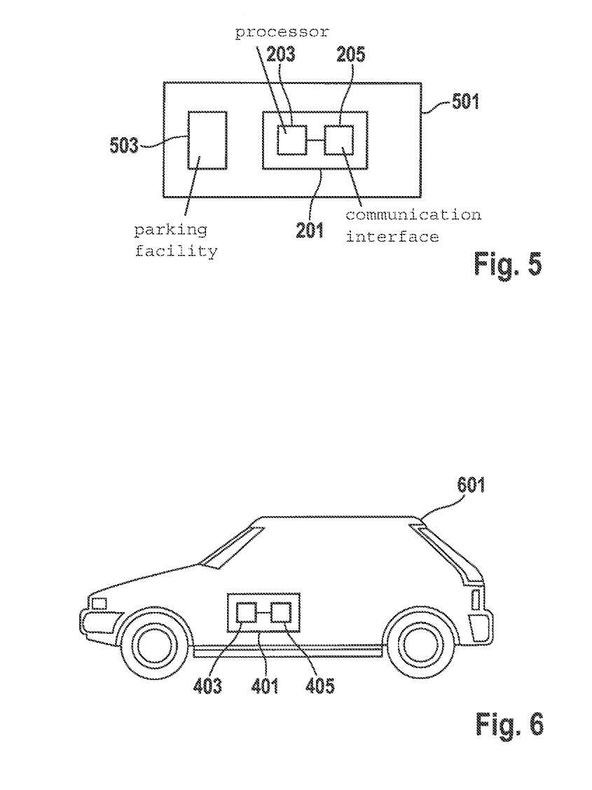

FIG. 5 shows a parking system 501 for vehicles.

Parking system 501 includes a parking facility 503 and apparatus 201 of FIG. 2.

FIG. 6 shows a vehicle 601.

Vehicle 601 includes apparatus 401 of FIG. 4.

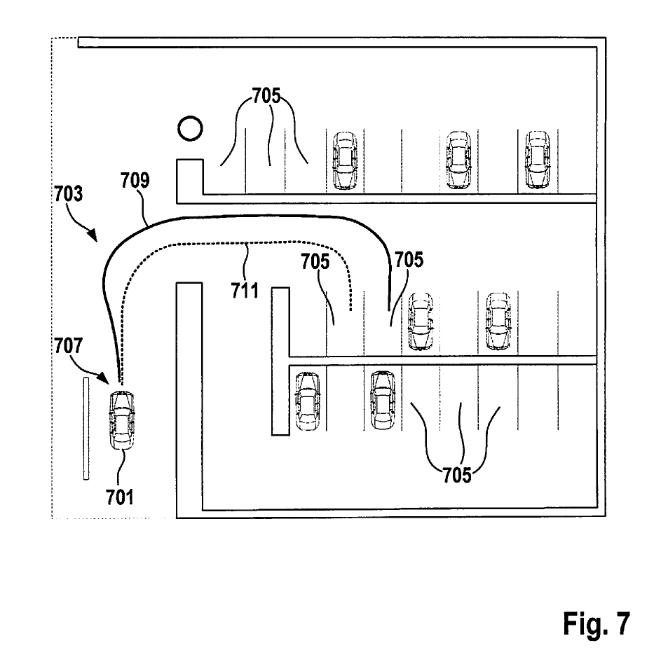

FIG. 7 shows a vehicle 701, which is located in a parking facility 703. Vehicle 701 has been parked at a drop-off position or at a drop-off location 707. From there, vehicle 701 will drive autonomously to a parking position, which is assigned to one of the many parking spaces 705 of parking facility 703. That is, the vehicle will thus drive autonomously to a parking space 705 in order to park there. The vehicle carries this out autonomously, thus, independently.

A setpoint trajectory, which is a function of a type of vehicle 701, is ascertained for the autonomous travel of vehicle 701 from drop-off position 707 to parking space 705, thus, to its parking position. Two setpoint trajectories 709 and 711 to be traversed are drawn in by way of example. So, for instance, setpoint trajectory 711 is ascertained if vehicle 701 is a relatively small vehicle, e.g., a mini. For example, setpoint trajectory 709 will be ascertained for a vehicle which is larger compared to the vehicle according to setpoint trajectory 711, e.g., if the vehicle is an “Audi A8.” In other words, the vehicle type thus notably includes a model of the vehicle, especially also a model year.

As shown as example in FIG. 7, setpoint trajectory 711 leads to a parking position in a more restricted manner than setpoint trajectory 709. Specifically, this is possible because a smaller vehicle usually has a smaller turning clearance circle, and in particular, needs less space for maneuvering.

It should be noted that the two ascertained setpoint trajectories 709 and 711 are only examples. For instance, other setpoint trajectories are provided for other vehicle types.

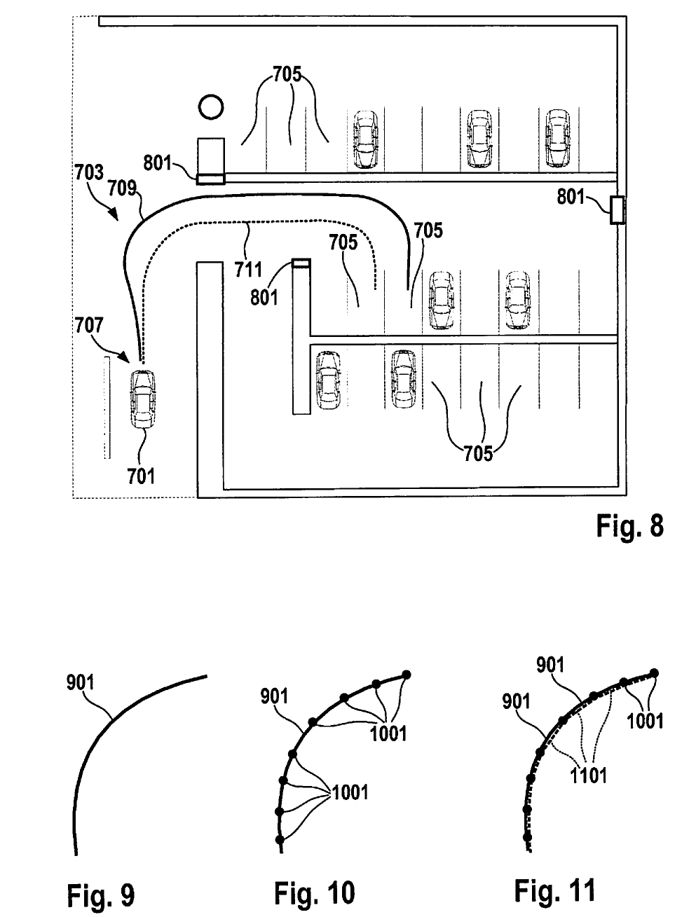

FIG. 8 shows parking facility 703 according to FIG. 7, additionally including localization-synchronization locations 801. These localization-synchronization locations 801 are located at various places in the parking facility and are used for synchronization or for checking whether or not the vehicle is traveling correctly over the setpoint trajectory communicated to it. In other words, when traveling over its setpoint trajectory, the vehicle therefore is able to check whether it is traveling over it correctly. Thus, this is accomplished with the aid of the localization-synchronization locations.

For example, these localization-synchronization locations 801 are relative to the corresponding setpoint trajectory, e.g., setpoint trajectory 709 or 711. Thus, for instance, a localization-synchronization location may be assigned the following information: At a specific point in setpoint trajectory 709 or 711, the localization-synchronization location is x meters away in the direction of an X-axis and y meters in the direction of a Y-axis and/or an angle between the specific point of setpoint trajectory 709 or 711 and one of the X-axis and Y-axis amounts to a predetermined angular value. Here, the X-axis and the Y-axis denote an abscissa and ordinate, respectively, of a Cartesian coordinate system. For example, the Cartesian coordinate system is a vehicle coordinate system. The X-axis runs in the direction of the transverse axis of the vehicle. The Y-axis runs in the direction of the longitudinal axis of the vehicle, thus, in the direction of travel.

The ascertained setpoint trajectory may be transmitted to vehicle 701 according to various specific embodiments. This is represented illustratively by FIGS. 9 through 11.

So, FIG. 9 shows an ascertained setpoint trajectory 901 which is transmitted as a whole, thus, without any approximation, to the vehicle via the communication network.

FIG. 10 shows setpoint trajectory 901 which, according to FIG. 10, is approximated by a sequence or series of points 1001. That is, according to FIG. 10, ascertained setpoint trajectory 901 is thus represented by a sequence or series of points 1001. For example, according to this specific embodiment, this approximated setpoint trajectory, thus, this series of points 1001, is transmitted to the vehicle. Advantageously, this is able to reduce a volume of data to be transmitted.

FIG. 11 shows setpoint trajectory 901, which is approximated by a sequence of straight lines 1101. In other words, the sequence or series of straight lines 1101 thus represents setpoint trajectory 901. The correspondingly approximated setpoint trajectory, thus, the series or sequence of straight lines 1101, is transmitted to the vehicle. In addition, points 1001 according to FIG. 10 are also marked in in FIG. 11 for comparison.

In further specific embodiments, combinations of the possibilities shown in FIG. 9 through 11 are provided. So, for example, one or more sections of setpoint trajectory 901 are approximated by a series or sequence of points, analogous to FIG. 10. Preferably, one or more sections of setpoint trajectory 901 are approximated by a series or sequence of straight lines, analogous to FIG. 11. Preferably, one or more sections of setpoint trajectory 901 are not approximated; these sections are therefore transmitted as a whole to the vehicle.

In particular, the present invention thus includes providing a technical and efficient way by which autonomous valet parking may be carried out by vehicles. According to the present invention, prior to carrying out the autonomous valet parking, an overall trajectory, thus, the setpoint trajectory to be traversed, is calculated or ascertained specifically for the vehicle, and in particular, specifically for the parking position, e.g., specifically for the parking spot, with the aid of a parking-place management system, for example. The vehicle then travels over this ascertained overall trajectory independently, thus, without being remotely controlled.

Within the context of this present invention, specifically means, in particular, that an adapted setpoint trajectory is calculated for each vehicle (e.g., “Audi A8”, “Mini”, “Golf”, “Passat”, etc.), and especially for each model (e.g., “Audi A8, model year 2011”). Preferably, the specifications of the vehicle like, for example, a wheel base, a motion-control regulator, etc., as well as, for instance, the parameters such as a height, a width and a length, are integrated into the setpoint-trajectory calculation or setpoint-trajectory ascertainment. In addition to or instead, preferably inaccuracies of the vehicle systems, especially of the driver assistance systems and/or of a driving-environment sensor system are also factored into the trajectory calculation.

The motion-control regulator is a processing device which calculates the implementation of a setpoint trajectory, that is, how individual actuators (brake, steering, drive) must be controlled so that the setpoint trajectory is traversed. In other words, the processing device is designed to calculate control parameters for one or more actuators, in order to be able to travel over the setpoint trajectory.

According to one specific embodiment, the driving-environment sensor system of the vehicle includes one or more driving-environment sensors like, for example: radar sensor, ultrasonic sensor, lidar sensor, laser sensor and video sensor.

The advantages of the example embodiments according to the present invention lie particularly in the fact that a great deal less information must be transmitted as compared to an extremely precise map. In particular, the vehicle does not have to be controlled remotely by a parking-garage management system, but rather drives independently, thus, autonomously. The parking-garage management system is therefore advantageously relieved of this task.

1-13. (canceled)

14. A method for the assisted guidance of a vehicle, comprising:
ascertaining a setpoint trajectory to be traversed in a parking facility for the vehicle as a function of a type of the vehicle;
transmitting the ascertained setpoint trajectory to the vehicle via a communication network so that the vehicle is able to drive autonomously in the parking facility based on the setpoint trajectory.

15. The method as recited in claim 14, wherein the setpoint trajectory is also ascertained as a function of at least one of the following vehicle parameters: i) wheel base, ii) height, iii) width, iv) length, v) mass, vi) functional scope of a driver assistance system, vii) functional scope of a driving-environment sensor system, viii) maximum steering angle, ix) turning clearance circle, x) inexactness of a driver assistance system, xi) inexactness of a driving-environment sensor system, xii) specific type and/or a specific inexactness of one or more actuators, and/or of a processing device for calculating control parameters for one or more actuators, in order to be able to travel over the setpoint trajectory.

16. The method as recited in claim 14, wherein at least one localization-synchronization location is determined, by which the vehicle is able to check whether it is traveling correctly over the ascertained setpoint trajectory, the localization-synchronization location being transmitted via the communication network to the vehicle so that when traversing the setpoint trajectory, the vehicle is able to check, with the aid of the localization-synchronization location, whether it is traveling correctly over the setpoint trajectory.

17. The method as recited in claim 16, wherein the determination of the localization-synchronization location includes that position data of the localization-synchronization location is determined relative to the setpoint trajectory.

18. The method as recited in claim 14, wherein prior to the transmission, at least one section of the ascertained setpoint trajectory is approximated by one of a straight line or a sequence of points, so that the setpoint trajectory with the approximated section is transmitted to the vehicle via the communication network.

19. The method as recited in claim 14, wherein the setpoint trajectory includes at least one of the following locations in the parking facility: i) a drop-off position at which a driver of the vehicle is able to drop off his vehicle for an autonomous parking process, ii) a parking position in which the vehicle parks in the parking facility, and iii) a pick-up position at which a driver of the vehicle is able to pick up the vehicle at the end of an autonomous parking process.

20. The method as recited in claim 14, wherein the transmission of a digital map of the parking facility to the vehicle via the communication network is dispensed with.

21. An apparatus for the assisted guidance of a vehicle, comprising:
a processor designed to ascertain for the vehicle a setpoint trajectory to be traversed in a parking facility as a function of a type of the vehicle; and
a communication interface designed to transmit the ascertained setpoint trajectory to the vehicle via a communication network, so that the vehicle is able to travel autonomously in the parking facility based on the setpoint trajectory.

22. A method for operating a vehicle, comprising:
receiving, by the vehicle via a communication network, a setpoint trajectory, which is a function of a type of the vehicle and is to be traversed in a parking facility; and
autonomously traveling, by the vehicle, in the parking facility based on the setpoint trajectory.

23. An apparatus for operating a vehicle, comprising:
a communication interface which is designed to receive, via a communication network, a setpoint trajectory that is a function of a type of the vehicle and is to be traversed in a parking facility; and
a guidance device for guiding the vehicle, which is designed to guide the vehicle autonomously in the parking facility based on the setpoint trajectory.

24. A parking system for vehicles, comprising:
a parking facility; and
an apparatus for the assisted guidance of a vehicle, including a processor designed to ascertain for the vehicle a setpoint trajectory to be traversed in the parking facility as a function of a type of the vehicle, and a communication interface designed to transmit the ascertained setpoint trajectory to the vehicle via a communication network, so that the vehicle is able to travel autonomously in the parking facility based on the setpoint trajectory.

25. A vehicle, comprising an apparatus for operating the vehicle, the apparatus including a communication interface which is designed to receive, via a communication network, a setpoint trajectory that is a function of a type of the vehicle and is to be traversed in a parking facility, and a guidance device for guiding the vehicle, which is designed to guide the vehicle autonomously in the parking facility based on the setpoint trajectory.

26. A non-transitory computer-readable storage medium on which is stored a computer program, including program code for the assisted guidance of a vehicle, the computer program, when executed by a computer, causing the computer to perform:
ascertaining a setpoint trajectory to be traversed in a parking facility for the vehicle as a function of a type of the vehicle;
transmitting the ascertained setpoint trajectory to the vehicle via a communication network so that the vehicle is able to drive autonomously in the parking facility based on the setpoint trajectory.
